(19) United States
(12) Patent Application Publication
(10) Pub. No.: US 2014/0057615 A1
(43) Pub. Date: Feb. 27, 2014

(54) APPARATUS TO SELF-ACTIVATE AND SELF-CONFIGURE A DEVICE AND SYSTEM AND A METHOD THEREOF

(71) Applicants: David E. Berry, Basking Ridge, NJ (US); Sanida Bratt, Chicago, IL (US); Sumeet S. Paul, Evanston, IL (US)

(72) Inventors: David E. Berry, Basking Ridge, NJ (US); Sanida Bratt, Chicago, IL (US); Sumeet S. Paul, Evanston, IL (US)

(73) Assignee: SYNCHRONOSS TECHNOLOGIES, INC., Bridgewater, NJ (US)

(21) Appl. No.: 13/591,081

(22) Filed: Aug. 21, 2012

(51) Int. Cl. H04W 8/18; H04W 88/02

(52) U.S. Cl. 455/418; 455/558

(57) ABSTRACT

Embodiments of the present invention allows a telecommunications provider to embed activation and configuration logic into SIM cards that consumers install in their wireless devices. The activation and configuration logic on a SIM card ensures that a wireless device is activated and properly configured to operate on a network. In some embodiments, the configuration logic on the SIM card also ensures that the wireless device is properly configured with backed up personal data and provisioned with services that a consumer had previously or is subscribed to. Typically, the wireless device is able to self-activate and self-configure when the SIM card is installed the wireless device.

### FIELD OF THE INVENTION

The present invention relates to wireless telephone networks. More particularly, the present invention relates to an apparatus to self-activate and self-configure a device on such networks and a system and a method thereof.

### BACKGROUND OF THE INVENTION

Prior art SIM cards simply identify and authenticate subscribers on wireless devices. Typically, when a consumer signs up for wireless service at a store, a new wireless device and a prior art SIM card are simultaneously sold to the consumer. A representative of a telecommunications provider typically activates and configures the wireless device before, during and/or after the telecommunications provider puts the prior art SIM card into the wireless device such that the wireless device is able to properly operate on a telecommunications network.

A trend in the mobile arena is that consumers are now starting to buy wireless devices separately from SIM cards. Virgin Mobile, Cricket and Metro PCS, to name a few, are telecommunications providers that sell consumers only SIM cards. When a consumer puts a separately purchased SIM card in a wireless device, a telecommunications provider still needs to manually configure the wireless device such that the wireless device at least works properly on the network. In some instances, the telecommunications provider is able to instead drive the consumer through long configuration steps to manually configure the wireless device. Telecommunications providers, however, are currently unable to provide automated activation and configuration to consumers who only buy SIM cards and not wireless devices.

The present invention addresses at least these limitations in the prior art.

### SUMMARY OF THE INVENTION

Embodiments of the present invention allows a telecommunications provider to embed activation and configuration logic into SIM cards that consumers install in their wireless devices. The activation and configuration logic on a SIM card ensures that a wireless device is activated and properly configured to operate on a network. In some embodiments, the configuration logic on the SIM card also ensures that the wireless device is properly configured with backed up personal data and provisioned with services that a consumer had previously or is subscribed to. Typically, the wireless device is able to self-activate and self-configure when the SIM card is installed the wireless device.

In one aspect, a removable module is provided. The removable module includes an integrated circuit configured to store identification information about a subscriber, automatically activate a wireless device on a network, and retrieve information to configure the wireless device for use on the network. The information can include data to personalize the wireless device, software needed by a telecommunications provider, and/or other information needed by the wireless device to function.

In some embodiments, the integrated circuit is configured to store data for automatic navigation to a first predetermined location to access an activation service and to a second predetermined location to access a configuration service.

In some embodiments, the removable module is positioned within a locus of the wireless device.

In another aspect, a method of setting up a wireless device on a network for use is provided. The method includes detecting that the wireless device is on the network for a first time, automatically activating the wireless device on the network, and automatically configuring the wireless device for use on the network.

In some embodiments, the method includes, before detecting that the wireless device is on the network for a first time, receiving a removable module within a locus of the wireless device. In some embodiments, the removable module is configured to access an activation service to automatically activate the wireless device, and to access a configuration service to retrieve configuration information. In some embodiments, the removable module is a SIM card.

In some embodiments, automatically configuring the wireless device includes accessing a configuration server from the wireless device, and retrieving software on the wireless device required by a telecommunications provider.

In some embodiments, automatically configuring the wireless device includes determining whether a consumer of the wireless device is subscribed to one or more value-added services, accessing a configuration server from the wireless device, and provisioning the wireless device with the one or more value-added services. In some embodiments, provisioning the wireless device includes downloading and installing software associated with the one or more value-added services, retrieving backed up personal data, and/or both. The personal data can include calendar, SMS messages, photo album, notes, ringtones, email, and/or other suitable data.

In some embodiments, the method further includes removing a SIM card from a first wireless device, placing the SIM card in a second wireless device, and automatically configuring the second wireless device similarly as the first wireless device.

In yet another embodiment, a system is provided. The system includes a network, an activation service for activating wireless devices for use on the network, a configuration service for personalizing the wireless devices, a first wireless device, and a SIM card. The first network location can be the same as or different from the second network location. Typically, when the SIM card is communicatively coupled with the first wireless device, the SIM card is configured to enable the first wireless device to navigate to a first network location hosting the activation service, enable the first wireless device to navigate to a second network location hosting the configuration service, and retrieve personalization information from the configuration service.

In some embodiments, the system includes a second wireless device. In some embodiments, the SIM card, when communicatively coupled the second wireless device, is configured to enable the second wireless device to operate on the network, and to enable the second wireless device to be similarly configured as the first wireless device. In some embodiments, the SIM card includes activation and configuration logic.

### BRIEF DESCRIPTION OF THE DRAWINGS

Reference will now be made in detail to implementations of the present invention as illustrated in the accompanying drawings. The same reference indicators will be used throughout the drawings and the following detailed description to refer to the same or like parts.

FIG. 1 illustrates an exemplary system in accordance with the present invention.

FIG. 2 illustrates a block diagram of an exemplary wireless device configured to self-activate and self-configure in accordance with the present invention.

FIG. 3 illustrates an exemplary method of setting up a wireless device on a network in accordance with the present invention.

FIG. 4 illustrates an exemplary method of configuring a wireless device in accordance with the present invention.

FIG. 5 illustrates another exemplary method of configuring a wireless device in accordance with the present invention.

FIG. 6 illustrates an exemplary method of configuring a secondary device in accordance with the present invention.

### DETAILED DESCRIPTION OF THE INVENTION

In the following description, numerous details are set forth for purposes of explanation. However, one of ordinary skill in the art will realize that the invention may be practiced without the use of these specific details. Thus, the present invention is not intended to be limited to the embodiments shown but is to be accorded the widest scope consistent with the principles and features described herein.

Embodiments of the present invention allows a telecommunications provider to embed activation and configuration logic into SIM cards that consumers install in their wireless devices. The activation and configuration logic on a SIM card ensures that a wireless device is activated and properly configured to operate on a network. In some embodiments, the configuration logic on the SIM card also ensures that the wireless device is properly configured with backed up personal data and provisioned with services that a consumer had previously or is subscribed to. Typically, the wireless device is able to self-activate and self-configure when the SIM card is installed the wireless device.

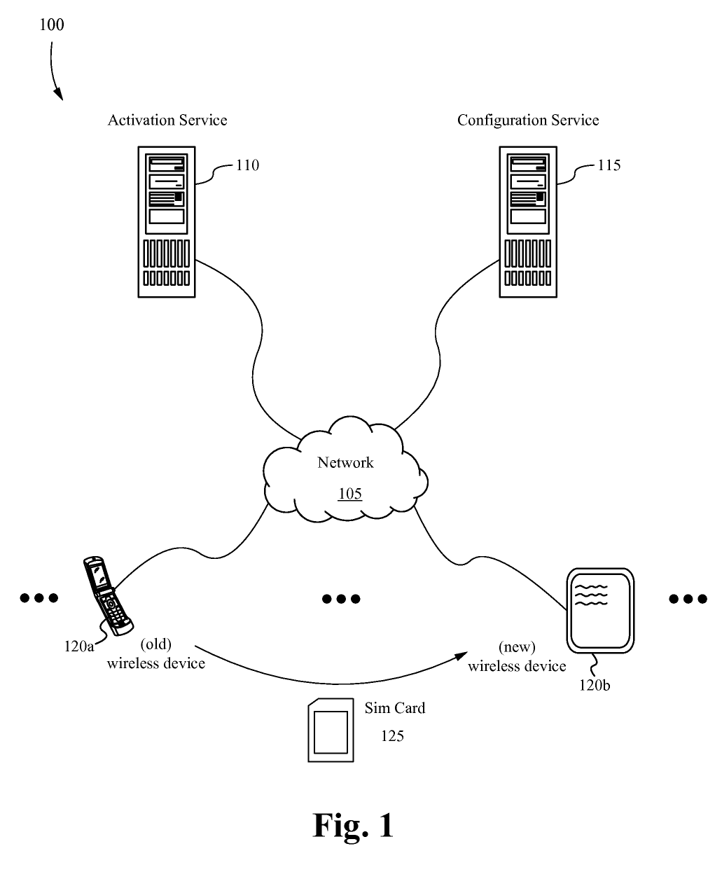

FIG. 1 illustrates an exemplary system 100 in accordance with the present invention. The system 100 includes a network 105, an activation service 110 and a configuration service 115. Typically, the network 105, the activation service 110 and the configuration service 115 are controlled or, at least accessed, by an telecommunications provider. The system 100 also includes one or more wireless devices 120a, 120b (collectively 120), and at least one SIM card 125 which provides a wireless device with access to the network 105. The activation service 110 is typically for activating wireless devices 120 for use on the network 105. The configuration service 115 is typically for configuring the wireless device 120 with services required by the network 105. The configuration service 115 can also be for personalizing the wireless devices 120. Each wireless device includes a locus. The locus is for receiving a SIM card of the present invention.

A SIM card of the present invention typically includes an integrated circuit configured to store identification number about a consumer or subscriber. In the foregoing, the terms consumer and subscriber are interchangeable. In some embodiments, the integrated circuit is also configured to store data for automatic navigation to a first predetermined location to access the activation service and to a second predetermined location to access the configuration service. The data can include network addresses of the first predetermined location and the second predetermined location. The first predetermined location can be the same as or different from the second predetermined location. In some embodiments, the integrated circuit is further configured to automatically activate a wireless device on a network and remotely retrieve information to configure the wireless device according to activation and configuration logic on the SIM card. The information includes software required by the telecommunications provider, data to personalize the wireless device, or both.

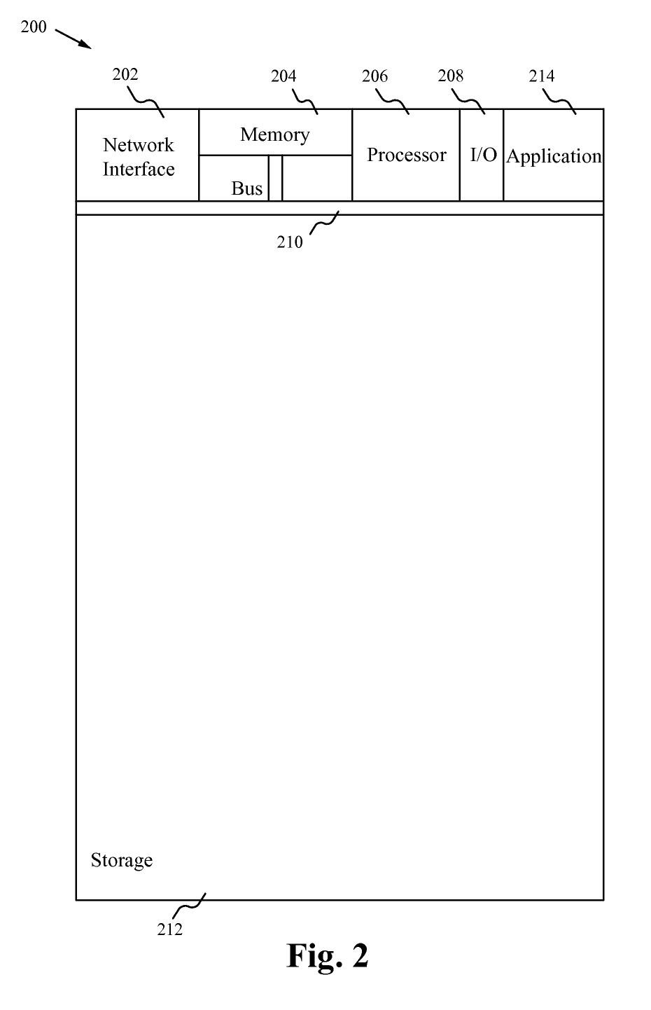

FIG. 2 illustrates a block diagram of an exemplary wireless device 200 configured to self-activate and self-configure in accordance with the present invention. The wireless device 200 is able to be used to acquire, store, compute, process, communicate and/or display information. For example, a wireless device 200 is self-activated and self-configured when a SIM card is received in a locus of the wireless device 200.

In general, a hardware structure suitable for implementing the wireless device 200 includes a network interface 202, a memory 204, a processor 206, I/O device(s) 208, a bus 210 and a storage device 212. The choice of processor is not critical as long as a suitable processor with sufficient speed is chosen. The memory 204 is able to be any conventional computer memory known in the art. The storage device 212 is able to include a hard drive, CDROM, CDRW, DVD, DVDRW, Blu-Ray®, flash memory card or any other storage device. The wireless device 200 is able to include one or more network interfaces 202 to connect to a cellular network, an Ethernet and/or other type of LAN. The I/O device(s) 208 are able to include one or more of the following: keyboard, mouse, monitor, display, printer, modem, touchscreen, button interface and other devices. In some embodiments, the hardware structure includes multiple processors and other hardware to perform parallel processing. Application(s) 214 acquired by a subscriber are likely to be stored in the storage device 212 and memory 204 and processed as applications are typically processed. More or fewer components shown in FIG. 2 are able to be included in the computing device 200.

Examples of suitable wireless devices include a cellular/mobile telephone (e.g. an iPhone®), a smart appliance, a tablet computer (e.g. an iPad®) or any other suitable computing device capable of receiving a SIM card for subscribing to telecommunications services.

Referring back to FIG. 1, when the SIM card 125 is communicatively coupled with a first wireless device such as a mobile telephone 120a of FIG. 1, the SIM card enables the first wireless device 120a to navigate to a first network location hosting the activation service 110, enables the wireless device to navigate to a second network location hosting the configuration service 115, and retrieves configuration information from the configuration service 115. In some embodiments, the configuration information includes personalization information. When the SIM card 125 is communicatively decoupled from the first wireless device 120a and communicatively coupled with a second wireless device such as a table computer 120b, the SIM card 125 enables the second wireless device 120b to operate on the network 105, and enables the second wireless device 120b to be similarly configured as the first wireless device 120a.

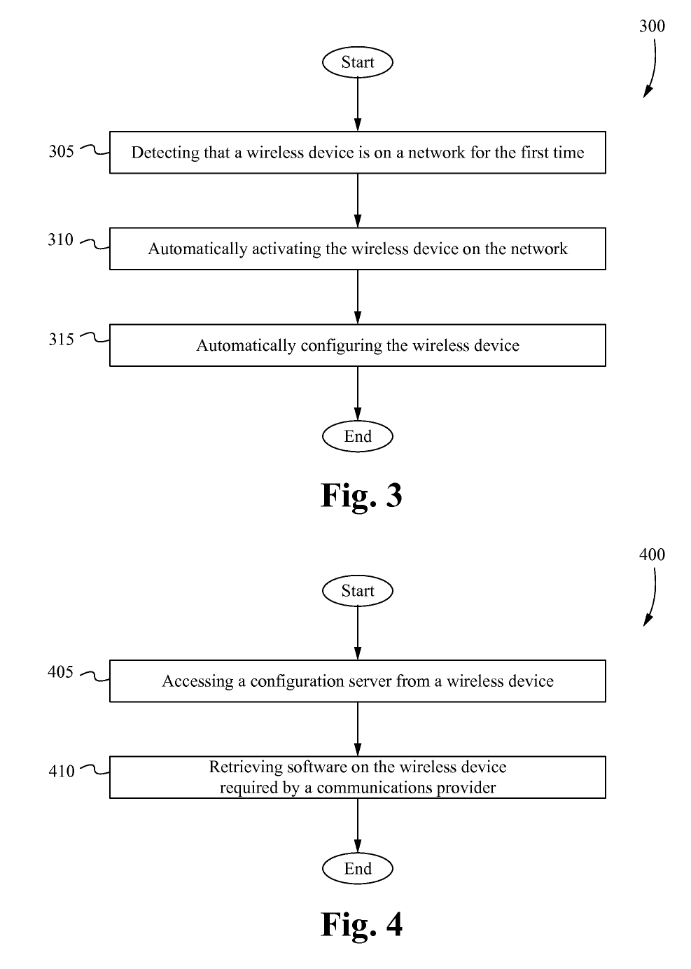

FIG. 3 illustrates an exemplary method 300 of setting up a wireless device on a network in accordance with the present invention. The method 300 begins at a step 305, where the wireless device is detected on the network for a first time. For example, the subscriber has recently obtained the wireless device for use on the network, and a removable module is installed in a locus of the wireless device. In some embodiments, the removable module is a SIM card of the present invention. As discussed elsewhere, the SIM card of the present invention includes activation and configuration logic and, based on the logic, is configured to access an activation service to automatically activate the wireless device and to access a configuration service to retrieve configuration information. At a step 310, the wireless device is automatically activated on the network using the activation logic on the SIM card. At a step 315, the wireless device is automatically configured using the configuration logic on the SIM card. Exemplary configuration methods are discussed in FIGS. 4-6. After the step 315, the method 300 ends.

FIG. 4 illustrates an exemplary method 400 of configuring a wireless device in accordance with the present invention. The method 400 begins at a step 405, where a configuration server is accessed from the wireless device. In some embodiments, the logic in the SIM card includes the network address of the configuration server and/or other identifying information about the configuration server. In some embodiments, the configuration server is the same server that provides the activation service. Typically, the configuration server provides the configuration service and is accessed by the wireless device after the wireless device is activated. The configuration server is typically provided by the wireless device with identifying information of the wireless device, for example, make and model. At a step 410, software required by the telecommunications provider is thereafter retrieved on the wireless device. This software is based on the identifying information provided by the wireless device and is necessary for the wireless device to work properly on the network. After it downloads, the software is configured to execute or install on the wireless device. After the step 410, the method 400 ends. Typically, the wireless device is thereafter configured for proper use on the network.

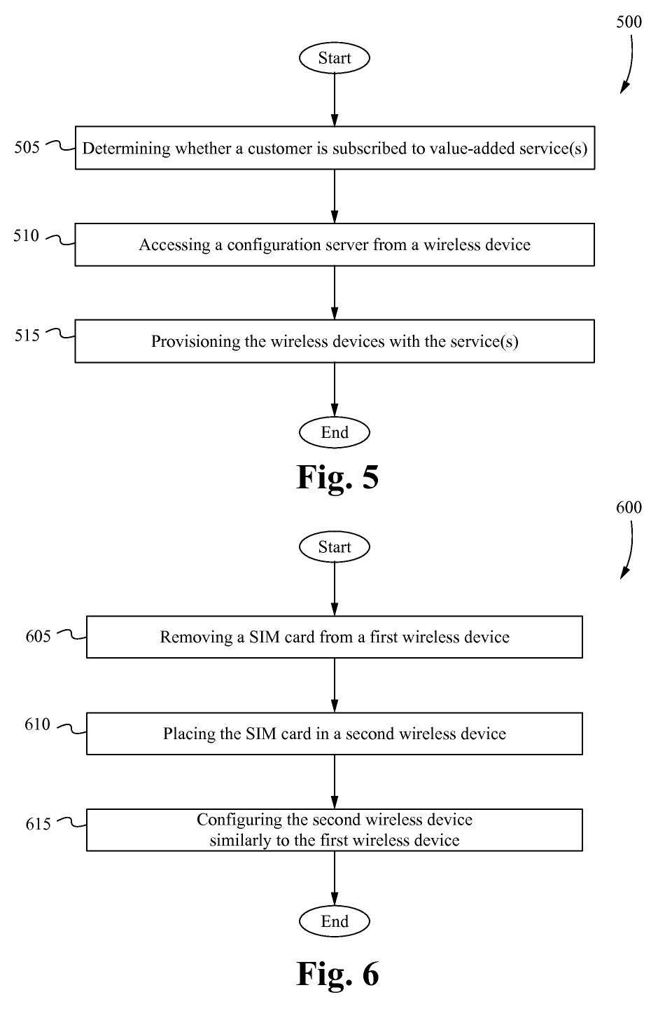

In some situations, a wireless device can be further configured after the software required by the telecommunications provider is retrieved and installed on the wireless device. FIG. 5 illustrates another exemplary method 500 of configuring a wireless device in accordance with the present invention. The method 500 begins at a step 505, where it is determined whether the consumer of the wireless device is subscribed to one or more value-added services. In some embodiments, the consumer is prompted on the wireless device whether the consumer is a customer of a backup service, such as the MightyBackup™ service provided by Synchronoss Technologies, Inc. of Bridgewater, N.J. Based on the determination, at a step 510, the configuration server is accessed from the wireless device. In some embodiments, the consumer must provide the customer's account information for retrieving the one or more value-added services. After retrieving the one or more value-added services on the wireless device, at a step 515, the wireless device is provisioned with the one or more value-added services. In some embodiments, software associated with the one or more value-added services is downloaded and installed on the wireless device. Alternatively or in addition to, backed up personal data are updated onto the wireless device. Personal data include, but are not limited to, calendar, SMS messages, photo album, notes, ringtones, email and other data suitable for backup. After the step 515, the method 500 ends. In some embodiments, the wireless device thereafter is similarly configured as another wireless device previously used by the consumer.

The present invention advantageously allows the consumer to use the same SIM card with a different wireless device that is recently purchased or otherwise obtained for use on the network, with minimal or no user intervention during device activation and configuration of the different wireless device. FIG. 6 illustrates an exemplary method 600 of configuring a secondary device in accordance with the present invention. The method 600 begins at a step 605, where a SIM card is removed from a first wireless device. Upon removing the SIM card, the first wireless device is no longer able to operate on the network. At a step 610, the SIM card is placed in a second wireless device. In some embodiments, the second wireless device self-activates when the SIM card is placed in the second wireless device; the wireless device is automatically activated on the network using the activation logic on the SIM card. At a step 615, the second wireless device is similarly configured as the first wireless device. The second wireless device is at least network configured. The second wireless device is also configured with any one or more value-added services and/or updated with any backed up personal data via, for example, the MightyBackup™ service. After the step 615, the method 600 ends.

Embodiments of the present invention are directed to an apparatus to self-activate and self-configure a device on such networks and a system and a method thereof. A SIM card of the present invention includes activation and configuration logic which advantageously enables a wireless device to self-activate and self-configure to operate on a network with minimal or no user intervention. The logic includes data for automatic navigation to an activation service and to a configuration service. The activation service activates the wireless device. The configuration service ensures that the wireless device is properly configured to work on a communications network and that the wireless device is backed up with personal data and provisioned with services that a consumer had previously subscribed to.

While the invention has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details, but rather is to be defined by the appended claims.

We claim:

1. A removable module comprising an integrated circuit configured to
a. store identification information about a subscriber;
b. automatically activate a wireless device on a network; and
c. retrieve information to configure the wireless device for use on the network.

2. The removable module of claim 1, wherein the integrated circuit is configured to store data for automatic navigation to a first predetermined location to access an activation service and to a second predetermined location to access a configuration service.

3. The removable module of claim 1, wherein the removable module is positioned within a locus of the wireless device.

4. The removable module of claim 1, wherein the information includes data to personalize the wireless device.

5. The removable module of claim 1, wherein the information includes software needed by a telecommunications provider.

6. A method of setting up a wireless device on a network for use, the method comprising:
a. detecting that the wireless device is on the network for a first time;
b. automatically activating the wireless device on the network; and
c. automatically configuring the wireless device for use on the network.

7. The method of claim 6, further comprising, before detecting that the wireless device is on the network for a first time, receiving a removable module within a locus of the wireless device.

8. The method of claim 7, wherein the removable module is configured to access an activation service to automatically activate the wireless device, and to access a configuration service to retrieve configuration information.

9. The method of claim 7, wherein the removable module is a SIM card.

10. The method of claim 6, wherein automatically configuring the wireless device comprises:
a. accessing a configuration server from the wireless device; and
b. retrieving software on the wireless device required by a telecommunications provider.

11. The method of claim 6, wherein automatically configuring the wireless device comprises:
a. determining whether a consumer of the wireless device is subscribed to one or more value-added services;
b. accessing a configuration server from the wireless device; and
c. provisioning the wireless device with the one or more value-added services.

12. The method of claim 11, wherein provisioning the wireless device includes downloading and installing software associated with the one or more value-added services.

13. The method of claim 11, wherein provisioning the wireless device includes retrieving backed up personal data.

14. The method of claim 13, wherein the personal data includes at least one of calendar, SMS messages, photo album, notes, ringtones, and email.

15. The method of claim 6, further comprising:
a. removing a SIM card from a first wireless device;
b. placing the SIM card in a second wireless device; and
c. automatically configuring the second wireless device similarly as the first wireless device.

16. A system comprising:
a. a network;
b. an activation service for activating wireless devices for use on the network;
c. a configuration service for personalizing the wireless devices;
d. a first wireless device; and
e. a SIM card, when communicatively coupled with the first wireless device, configured to:
1. enable the first wireless device to navigate to a first network location hosting the activation service;
2. enable the first wireless device to navigate to a second network location hosting the configuration service; and
3. retrieve personalization information from the configuration service.

17. The system of claim 16, wherein the first network location is the same as the second network location.

18. The system of claim 16, wherein the first network location is different from the second network location.

19. The system of claim 16, further comprising a second wireless device.

20. The system of claim 19, wherein the SIM card, when communicatively coupled the second wireless device, is configured to enable the second wireless device to operate on the network, and to enable the second wireless device to be similarly configured as the first wireless device.

21. The system of claim 16, wherein the SIM card includes activation and configuration logic.
